(19) United States
(12) Patent Application Publication
(10) Pub. No.: US 2026/0278621 A1
(43) Pub. Date: Sep. 17, 2026

(54) COMPUTING SYSTEM FOR CALCULATING CARBON EMISSIONS OF SEMICONDUCTOR PRODUCTS AND METHOD

(71) Applicant: SK hynix Inc., Icheon-si (KR)

(72) Inventors: Kyu-jin Choi, Icheon-si (KR); Hyuk-hwa Kwon, Icheon-si (KR); Yoon-jai Oh, Icheon-si (KR); Soon-hwa Lee, Icheon-si (KR); Eun-joo Lee, Icheon-si (KR); Yoon-je Cho, Icheon-si (KR); Ye-ji Choi, Icheon-si (KR)

(21) Appl. No.: 19/402,211

(22) Filed: Nov. 26, 2025

(30) Foreign Application Priority Data
Mar. 11, 2025 (KR) 10-2025-0031533

(51) Int. Cl. G06Q 30/018

(52) U.S. Cl. CPC G06Q 30/018; Y02P 10/10; Y02P 10/25

(57) ABSTRACT

A method for calculating carbon emissions of semiconductor products and a computing device using the same are disclosed, and more particularly, a method for indicating the environmental impact of a semiconductor product (DRAM, NAND, SSD, HBM, etc.) as a quantitative number using a unique product code thereof, and converting it into carbon emissions equivalents, thereby evaluating the carbon emissions.

### CROSS-REFERENCE TO RELATED APPLICATIONS

The present application claims priority under 35 U.S.C. §119(a) to Korean application number 10-2025-0031533, filed on Mar. 11, 2025, in the Korean Intellectual Property Office, which is incorporated herein by reference in its entirety.

### BACKGROUND

### Technical Field

The present disclosure relates to a method for calculating carbon emissions equivalents of semiconductor products and a computing device using the same, and more particularly, to a method for indicating the environmental impact of a semiconductor product (DRAM, NAND, SSD, HBM, etc.) as a quantitative number using a unique product code thereof, and converting it into carbon emissions equivalents, thereby evaluating environmental impacts using the carbon emissions equivalents.

### Related Art

The rapid advancement of industry inevitably leads to the destruction of the natural environment. As the severity of this problem becomes increasingly apparent, modern society is shifting toward a new paradigm of “eco-friendliness” that takes into account not only technological advancement but also environmental impact. In particular, as a quantitative indicator of environmental impact, carbon emissions are becoming a key element of environmental assessment. Comparative analysis of carbon emissions and efforts to reduce carbon emissions are emerging as fundamental and critical issues for reducing environmental impacts.

The semiconductor industry is a highly technology-intensive industry, in which products are produced through numerous process steps. The semiconductor manufacturing processes are extremely complex and diverse, and each process step consumes a lot of energy and raw materials, resulting in high carbon emissions.

Conventionally, carbon emissions are classified into Scope 1 (direct emissions), Scope 2 (indirect emissions), and Scope 3 (indirect emissions). Here, Scope 1 (direct emissions) includes fixed combustion (e.g., LNG), process emissions, and mobile combustion. Scope 2 (indirect emissions) includes power and steam. Scope 3 (indirect emissions) has a total of 15 categories, including purchased goods and services, capital goods, and fuel-related and energy-related activities not included in Scope 1 and Scope 2. However, data collection in the indirect emissions category is complicated and difficult, and it is possible to identify only total emissions at a company-wide level, making it difficult to calculate carbon emissions by individual product or by individual process.

This serves as a major obstacle in setting carbon emission reduction targets and establishing effective carbon emission reduction strategies. In addition, carbon emission information of semiconductor products serves as an important factor in demonstrating the eco-friendliness of the products to customers and stakeholders and in securing competitiveness. However, it is difficult to obtain accurate data, and considering the cost and time required for product certification, there are practical limitations.

Thus, there is a need to develop a systematic calculation method and an automatic computing system capable of accurately and efficiently calculating the carbon emissions of individual semiconductor manufacturing products. Such information can be used to calculate the carbon emission equivalent for a semiconductor product associated with a unique product code. As used herein, a carbon emissions equivalent for a semiconductor product means the carbon emission impact of the materials used in the manufacture of the semiconductor product, and carbon emissions equivalent and carbon emissions may be used interchangeably when referring to a semiconductor product. This information may significantly contribute to corporate compliance with environmental regulations and fulfillment of corporate social responsibilities.

### SUMMARY

The present disclosure has been devised to solve the above problems, and an objective of the present disclosure is to provide a method for quantitatively displaying a numerical value representing the environmental impact of a semiconductor product, when a product code, which is a unique product number of the semiconductor product, is input, thereby calculating and evaluating carbon emissions.

Further, an objective of the present disclosure is to provide an automatic carbon emission computing system that can calculate carbon emissions at each stage, such as the front-end process, back-end process, packaging material, utility, and transportation method of a semiconductor product, sum them to obtain total carbon emissions, or separate the carbon emissions by each process to conveniently compare and analyze the carbon emissions within a process.

According to an embodiment of the present disclosure, a method for quantitatively calculating carbon emissions of a semiconductor product may include inputting a unique product code of the semiconductor product into a computing system having a display, calculating the carbon emissions by dividing amounts of raw materials and chemicals used in a manufacturing process of a plurality of semiconductor products by a production volume, and summing the calculated carbon emissions generated during the manufacturing process of the semiconductor product for each raw material and for each chemical to obtain a total carbon emission for the semiconductor product associated with the unique product code and displaying a graph of the calculated carbon emissions for the plurality of semiconductor products.

The method may further include, prior to calculating the carbon emissions, inputting into a database a carbon emission factor for each raw material and each chemical used to manufacture the semiconductor product, and matching each raw material and each chemical used to manufacture the semiconductor product to a respective carbon emission factor in the pre-stored database.

The calculating of the carbon emissions may include calculating the carbon emissions by dividing amounts of raw materials and chemicals used in a front-end process by the production volume, calculating the carbon emissions by dividing amounts of raw materials and chemicals used in a back-end process by the production volume, calculating the carbon emissions by dividing amounts of packaging materials used by production volume, calculating the carbon emissions by dividing an amount of energy used to manufacture the plurality of semiconductor products by production volume, and calculating the carbon emissions by dividing a transportation distance using a transportation method by production volume.

An computing system for calculating carbon emissions of a semiconductor product includes a database configured to pre-store carbon emission factors associated with a plurality of raw materials and a plurality of chemicals used to manufacture a semiconductor product, a data collector configured to collect basic data on the semiconductor product, including process-specific data, and data on packaging materials, energy, waste, and transportation method, a calculation component configured to automatically calculate carbon emissions based on usage of the plurality of raw materials and the plurality of chemicals used in the semiconductor product and associated carbon emission factors according to a unique product code of the semiconductor product, and a data refinement and correction component configured to detect and correct errors in the data collected by the data collector.

The data collector may include a basic data collector configured to collect a product name, code, raw material code, and manufacturing information of the semiconductor product, a front-end process data collector configured to collect process-specific raw material usage, product-specific usage, and production volume for calculating the carbon emissions per wafer or chip unit of the semiconductor product, a back-end process data collector configured to collect actual raw material usage, raw material withdrawal records, and production performance data of the semiconductor product, a packaging material data collector configured to collect packaging material usage of the semiconductor product, a utility data collector configured to collect an amount of power used, an amount of fuel used, and an amount of waste generated during a manufacturing process of the semiconductor product, and a logistics data collector configured to collect a raw material supplier location, a logistics transportation distance, and a transportation method for the semiconductor product.

The calculation component may include a data matcher configured to match the carbon emission factors previously stored in the database with the plurality of raw materials and the plurality of chemicals, a data converter configured to convert units of the raw materials and chemicals into kilogram units, and a carbon emission calculator configured to calculate monthly usage based on the previously collected data, and to calculate the carbon emissions using the monthly usage, conversion to kilogram units, and carbon emission factors.

The system may further include a pathway-specific carbon emission analyzer configured to calculate respective emissions according to carbon emission pathways based on the carbon emissions calculated according to the unique product code of the semiconductor product, and a process searcher configured to reduce the usage of raw materials and chemicals for each semiconductor product based on the calculated carbon emissions according to the unique product code of the semiconductor product.

Unlike a conventional carbon emission calculating method based on emission scopes (scope 1, 2, and 3), a method for calculating carbon emissions of a semiconductor product according to the present disclosure can quantitatively calculate carbon emissions based on a unique product code of a semiconductor product by dividing the total usage of raw materials, chemicals, and energy throughout an entire semiconductor manufacturing process and a logistics stage by the production volume of the product.

Further, an automatic carbon emission computing system according to the present disclosure can analyze and utilize carbon emissions from various perspectives, including by business site, by category, by semiconductor product group, and by emission scope (Scope 1, 2, and 3).

Furthermore, the present disclosure can calculate carbon emissions by individual process and by individual product. These results can be used to establish and compare standards for materials and carbon emissions required to manufacture individual semiconductor products. Data analysis can be utilized to identify processes that reduce the amount of raw materials and chemicals used for each product, thereby reducing carbon emissions.

Furthermore, the present disclosure can secure semiconductor product production and competitiveness by providing the calculated carbon emission data to customers and stakeholders.

### BRIEF DESCRIPTION OF THE DRAWINGS

FIG. 1 is a flowchart illustrating a method for calculating carbon emissions of a semiconductor product, according to an embodiment of the present disclosure.

FIG. 2 is a diagram illustrating an automatic carbon emission computing system according to an embodiment of the present disclosure.

FIG. 3 is a diagram illustrating a calculation component of an automatic carbon emission computing system according to an embodiment of the present disclosure.

FIG. 4 is a diagram illustrating automatic carbon emission calculation results according to an embodiment of the present disclosure.

FIGS. 5A to 5B are diagrams illustrating data collected for carbon emission calculations according to an embodiment of the present disclosure.

### DETAILED DESCRIPTION

Since the present disclosure may be changed in various ways and have various forms, specific aspects or embodiments thereof will be described in detail herein. However, this is not intended to limit the present disclosure to a specific embodiment, and instead the present disclosure is to be understood as including all modifications, equivalents, or substitutes that fall within the spirit and scope of the present disclosure.

The terminology used herein is for the purpose of describing particular aspects or embodiments only and is not intended to be limiting. In the present disclosure, the singular forms are intended to include the plural forms as well, unless the context clearly indicates otherwise. It will be further understood that the terms “comprise”, “include”, etc. when used herein, specify the presence of stated features, integers, steps, operations, elements, components, and/or combinations of them but do not preclude the possibility of the presence or addition of one or more other features, integers, steps, operations, elements, components, and/or combinations thereof.

Unless otherwise defined, all terms including technical and scientific terms used herein have the same meaning as commonly understood by one of ordinary skill in the art to which the present disclosure belongs. Terms defined in commonly used dictionaries should be interpreted as having a meaning that is consistent with their meaning in the context of the relevant art and will not be interpreted in an idealized or overly formal sense unless expressly so defined herein.

The terms “first,” “second,” etc., described herein are only used to distinguish one component from another component, and are not limited by the manufacturing order. The names may not be consistent in the detailed description of the present disclosure and the claims.

The present disclosure relates to a method for calculating carbon emissions using a numerical value for environment impact of each semiconductor product using a unique product code of the product, and an automatic computing system using the same. This enables environmental performance between existing and new products to be conveniently compared and analyzed.

Hereinafter, a method for calculating carbon emissions of a semiconductor product and an automatic computing system using the same according to the present disclosure will be described in detail with reference to the accompanying drawings.

Semiconductor products typically include a memory, and examples include DRAM, NAND, SSD, HBM, etc. The detailed description of the present disclosure below assumes a typical semiconductor product, but embodiments are not limited thereto.

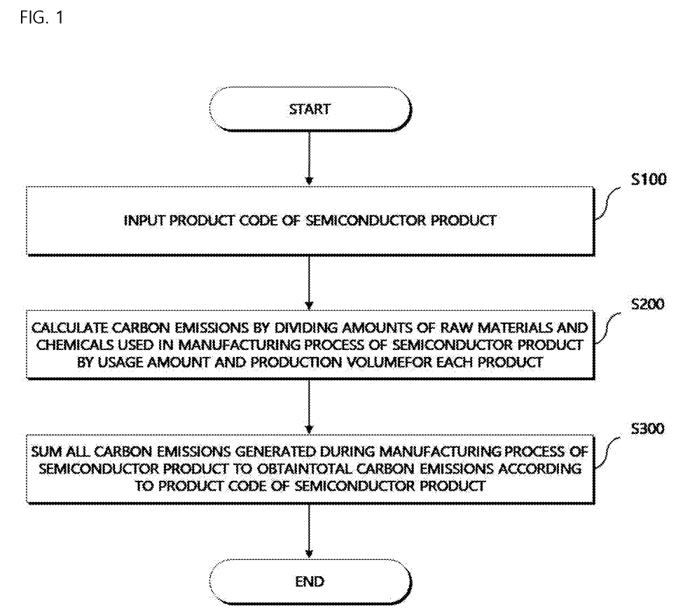

FIG. 1 is a flowchart illustrating a method for calculating carbon emissions of a semiconductor product, according to an embodiment of the present disclosure.

As shown in FIG. 1, a method for calculating the carbon emissions of a semiconductor product include step S100 of inputting a unique product code of the semiconductor product, step S200 of calculating the carbon emissions by dividing the amount of raw materials and chemicals used in a manufacturing process of the semiconductor product by usage and a production volume for each product, and step S300 of summing all the carbon emissions generated during the manufacturing process of the semiconductor product to obtain total carbon emissions according to the unique product code of the semiconductor product.

Herein, a semiconductor product refers to a product comprising one or more semiconductor dies or chips manufactured by the applicant, and includes individual ICs, packaged chips, modules, or assembled devices. For example, it may include memory chips such as DRAM and NAND, HBM modules, and SSD storage devices. Furthermore, a unique product code is a unique identifier assigned to a product manufactured by the applicant, and may be generated and managed by an internal manufacturing management system. The product code may be assigned differently based on the type and specifications of the product and may be linked to a database. The unique product code may be inscribed on the surface of a chip, printed on a label of the product packaging, or queried from software within the device.

Hereinafter, a detailed description of each step of the present disclosure is provided.

In step S100, a unique product code of the semiconductor product that is being produced is obtained as an input and used to identify the product information, raw material information, raw material code, and content information for each product.

The method may include step S150 (not illustrated), in which a carbon emission factor for each raw material and chemical of the semiconductor product is obtained as an input. At this time, carbon emission factors may be linked to a matching value by matching of each raw materials and chemicals of the semiconductor product to information in a pre-stored database.

In step S200, carbon emissions are calculated by dividing the amount of the raw materials and chemicals used in the manufacturing process of the semiconductor product by the usage and production volume for each product. The calculations are preferably divided into front-end process, back-end process, packaging, utility, and logistics stages.

Although not illustrated in FIG. 1, step S200 may include one or more steps. For example, step S200 can include step S210 of calculating carbon emissions by dividing the amount of raw materials and chemicals used in a front-end process by the usage and production volume for each product, step S220 of calculating carbon emissions by dividing the amount of raw materials and chemicals used in a back-end process by the usage and production volume for each product, step S230 of calculating carbon emissions by dividing the amount of packaging materials used for each semiconductor product by the usage and production volume for each product, step S240 of calculating carbon emissions by dividing the amount of energy used for each semiconductor product by the usage and production volume for each product, and step S250 of calculating carbon emissions by dividing a transportation distance according to a transportation method for each semiconductor product by the usage and production volume for each product.

To calculate carbon emissions, the raw materials used in the front-end process and back-end process stages may be linked or matched to the carbon emission factor for each raw material. This linking or matching may be performed through a mapping of data pre-stored within a database. According to the unique product code, values for raw material usage and the carbon emission factor for each raw material are predefined. During the calculation process, the unique product code can be used to look up the corresponding values from a map and use them for the calculation.

The front-end processes mainly include a photolithography process, an etching process, a diffusion process, a thin film deposition process, cleaning and CMP (Chemical Mechanical Planarization) processes, while the back-end process includes a packaging process.

In step S240, the energy used for each semiconductor product includes both utility and energy consumption, such as power, LNG, and steam gas as non-limiting examples.

In step S300, all carbon emissions generated during the manufacturing process of the semiconductor product are summed and used to calculate the total carbon emissions according to the unique product code of the semiconductor product. Thus, in step S300 carbon emissions calculated in each of the aforementioned steps are summed to derive final carbon emissions of the semiconductor product.

The method for calculating the carbon emissions according to an embodiment of the present disclosure may quantitatively display a numerical value for the environmental impact of the product and evaluate it as a measurement of carbon emissions when the product number (i.e., a product code) is input into the system.

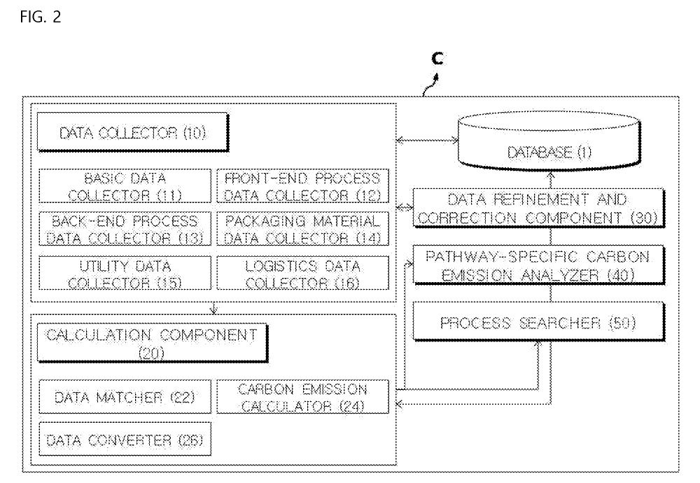

FIG. 2 is a diagram illustrating an automatic carbon emission computing system according to an embodiment of the present disclosure.

An automatic carbon emission computing system includes a database 1 in which carbon emission factors for raw materials and chemicals used in a semiconductor product are previously stored, a data collector 10 that collects basic data of the semiconductor product, process-specific data, and data on packaging materials, energy, waste, and transportation method, a calculation component 20 that automatically calculates quantitative carbon emissions based on the usage of raw materials and chemicals and carbon emission factors for each semiconductor product according to the unique product code of the semiconductor product, and a data refinement and correction component 30 that detects and corrects errors in the data collected by the data collector.

The database 1 includes carbon emission factor data for calculating carbon emissions. The carbon emission factors used may refer to international standards or industry standards. Stored carbon emission factors can include factors calculated by combining internal data from a semiconductor manufacturing company with externally certified emission factor data.

In addition, the database 1 may include all basic information such as product information, raw material information, and standard product components and raw materials, and may be connected to the data collector 10 and the calculation component 20 to transmit and receive data.

The data collector 10 includes a basic data collector 11 that collects the product name, code, raw material code, and manufacturing information of the semiconductor product, a front-end process data collector 12 that collects process-specific raw material usage, product-specific usage, and production volume used to calculate the carbon emissions per wafer or chip unit of the semiconductor product, a back-end process data collector 13 that collects the actual raw material usage, raw material withdrawal records, and production performance data of the semiconductor product, a packaging material data collector 14 that collects the packaging material usage of the semiconductor product, a utility data collector 15 that collects amounts of power and fuel used, and waste generated during the manufacturing process of the semiconductor product, and a logistics data collector 16 that collects the raw material supplier location, logistics transportation distance, and transportation method for the semiconductor product.

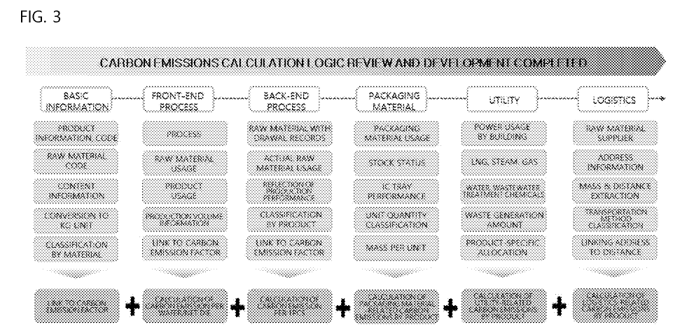

FIG. 3 is a diagram illustrating a calculation component of an automatic carbon emission computing system according to an embodiment of the present disclosure.

Referring to FIG. 3, input data for each step may be specifically identified. First, the basic data collector 11 may provide basic information including product information, raw material information, standard MSDS, content information, etc. The basic information may be linked to pre-stored carbon emission factors stored in a database 1 of FIG. 1. Next, the front-end process data collector 12 may provide information about process flow, raw material usage per front-end process, usage per product, and product production volume, and may calculate the carbon emissions per wafer or per net die for each process by linking the carbon emission factors to the raw materials used in each process.

The back-end process data collector 13 may provide information including the recordation of raw materials actually used, the actual raw material usage, and the actual production volume. By linking the carbon emission factors to the actual amount of raw materials used, the carbon emissions for each semiconductor product may be calculated. The back-end process data collector 13 may store the data separately according to the type or model of the manufactured semiconductor product.

The packaging material data collector 14 may provide data on the amount of packaging materials used, production volume based on IC trays or production volume packaged in individual units, and the mass of each individual product. The information may be used to calculate the carbon emissions generated during the packaging process for each semiconductor product. Semiconductor products may be packaged either in IC tray units or as individual units for transportation and storage. When the semiconductor products are packaged as the individual units, the mass may vary depending on the size or material of the product, and checking the mass information per unit is essential for accurately calculating carbon emissions.

The utility data collector 15 may provide information regarding power consumption used in the semiconductor manufacturing process, such as energy in the form of LNG, steam, and gas, utility usage, wastewater treatment chemicals and industrial water, and waste generation. The information may be used to calculate the utility carbon emissions for each semiconductor product produced.

The logistics data collector 16 includes information for calculating logistics-related carbon emissions, and may collect data such as the addresses of raw material suppliers, transportation distance to manufacturing plants, transportation methods, distances, etc. Furthermore, the data collected by each collector is used to calculate carbon emissions for its corresponding stage. Ultimately, these stage-specific carbon emissions are aggregated to determine the total carbon emissions of a specific semiconductor product.

The calculation component 20 includes a data matcher 22 that matches the carbon emission factors previously stored in the database, a data converter 26 that converts the units of raw materials and chemicals into kilogram units, and a carbon emission calculator 24 that calculates monthly usage based on the collected data and calculates the carbon emissions using the monthly usage, conversion to kilogram units, and carbon emission factors.

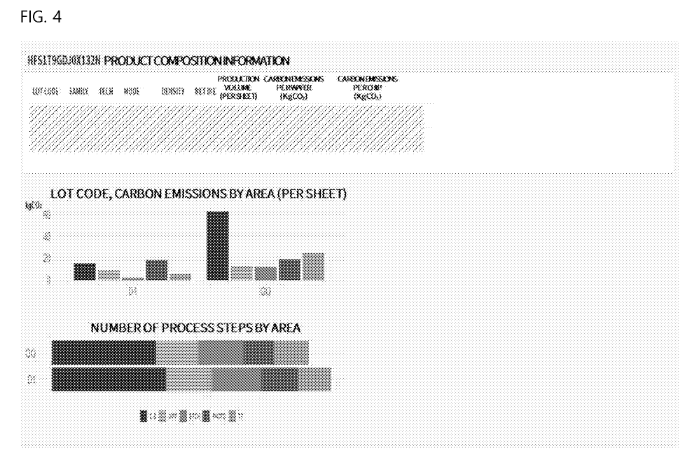

FIG. 4 is a diagram illustrating automatic carbon emission calculation results according to an embodiment of the present disclosure.

Referring to FIG. 4, result values calculated using an automatic carbon emission computing system are illustrated. When the unique product code and the production date of the semiconductor product are entered in the upper left corner, the product composition information and the carbon emission result values may be checked in a table and graph. FIG. 4 shows result values of carbon emissions from a front-end process. In the middle graph, the carbon emissions according to front-end processes cleaning & CMP CC, diffusion DIFF, etching ETCH, photolithography PHOTO, and thin film deposition TF, which are performed in this order, may be identified.

Regarding the product composition information, when a unique product code is entered into the automatic carbon emission computing system, a list of components required to assemble the corresponding final product, along with their specifications, production volume, and carbon emissions, can be presented. Specifically, FIG. 4 shows an example of an enterprise SSD (HFS1T9GDJ0X132N), illustrating information on the NAND memory chips and DRAM chips required to manufacture a single final product. For each component, the lot code specifies the lot from which the chip was produced, allowing the manufacturing history that serves as the basis for the carbon emission calculation to be traced.

The unique product code can identify the final assembled product, and the lot code can be a code that identifies the manufacturing lot where the individual components included in the final product were produced. In this process, for efficient data management, carbon emissions can first be aggregated on a lot-by-lot basis rather than on a per-chip basis. The average carbon emissions per chip can be calculated by determining the total carbon emissions generated from the entire manufacturing process for a specific lot code and then dividing this total by the number of component chips produced in that lot. Finally, by referencing the product configuration information linked to the unique product code, the total carbon emissions for the final product can be calculated by multiplying the average carbon emissions of each component by the required number of chips and then summing all these values.

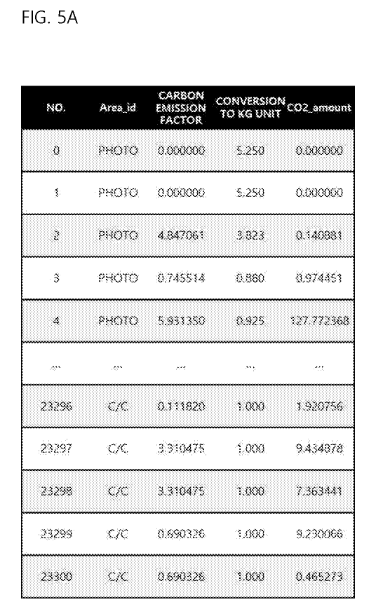

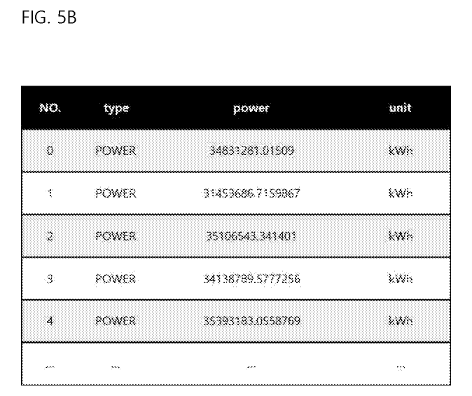

FIGS. 5A to 5B are diagrams illustrating data collected for carbon emission calculations according to an embodiment of the present disclosure.

Referring to FIG. 5A, in order to automatically calculate the carbon emissions of the semiconductor product, data stored in the database 1 and the data collector 10 is accessed to organize the basic information of the semiconductor product and the usage of raw materials and chemicals. Then, a carbon emission factor is matched to each raw material and chemical, and the management unit of various substances is converted to the unit of kilograms, so that carbon emissions may be calculated according to the calculation conditions.

In the carbon emission calculator 24, the carbon emissions may be calculated by multiplying the monthly usage, which is converted to kilograms, by the carbon emission factor. In the carbon emission calculator 24, the carbon emissions of each process and the carbon emissions of the entire semiconductor product may be analyzed and compared, making it possible to identify the processes that generate the most carbon dioxide and the products with the highest carbon emissions.

This system may be used not only to calculate the carbon emissions for each semiconductor product, but also to calculate and utilize carbon emission results from various perspectives such as by business site, by category, by semiconductor product group, and by emission scope (Scope 1, 2, and 3).

A semiconductor product group does not refer to a specific lot, chip, or wafer unit, but rather to a higher-level category such as DRAM, NAND, SSD, or HBM. For example, multiple products can be grouped based on criteria like the type of memory, the form of the final product, or a specific module. This calculation and analysis of carbon emissions by semiconductor product group makes it possible to macroscopically assess and manage the carbon competitiveness of an entire product line, going beyond individual product units.

FIG. 5B shows data on power consumption in the semiconductor manufacturing process by fabrication site FAB. By combining the power consumption of each FAB with an allocation factor, the power usage may be calculated when producing one semiconductor product. Furthermore, by combining the power usage with the carbon emission factor for power use, the carbon emissions from power use may be calculated when producing one product per each FAB.

In addition, referring to FIG. 2, the automatic carbon emission computing system according to an embodiment of the present disclosure may further include a pathway-specific carbon emission analyzer 40 that calculates the emissions according to carbon emission pathways such as Scope 1 (direct emissions), Scope 2 (indirect emissions), and Scope 3 (other indirect emissions), based on the carbon emissions calculated according to the unique product code of the semiconductor product, and a process searcher 50 that reduces the usage of raw materials and chemicals for each semiconductor product based on the calculated carbon emissions according to the unique product code of the semiconductor product.

To reduce carbon emissions, this system may be used to explore processes that may reduce the usage of raw materials and chemicals for each semiconductor product through various data analyses, or to set standards for carbon emission reduction targets.

According to an aspect of the present disclosure, the process may be split into additional steps or combined into fewer steps. Also, some steps may be omitted as needed, and the order of the steps may be changed.

The present disclosure described above with reference to the accompanying drawings can be modified and changed in various ways by those skilled in the art, and such modifications and changes that are not limited by the claims should be interpreted as being included within the scope of the present disclosure.

What is claimed is:

1. A method for quantitatively calculating carbon emissions of a semiconductor product comprising:
inputting a unique product code of a semiconductor product into a computing system having a display;
calculating carbon emissions by dividing amounts of raw materials and chemicals used in a manufacturing process of a plurality of semiconductor products by a production volume;
summing the calculated carbon emissions generated during the manufacturing process of the semiconductor product for each raw material and for each chemical to obtain a total carbon emission for the semiconductor product associated with the unique product code; and
displaying a graph of the calculated carbon emissions for the plurality of semiconductor products.

2. The method according to claim 1, further comprising:
prior to the calculating of the carbon emissions, inputting into a database a carbon emission factor for each raw material and each chemical used to manufacture the semiconductor product, and
matching each raw material and each chemical used to manufacture the semiconductor product to a respective carbon emission factor in a pre-stored database.

3. The method according to claim 1, wherein the calculating of carbon emissions comprises:
calculating carbon emissions by dividing amounts of raw materials and chemicals used in a front-end process by the production volume; and
calculating carbon emissions by dividing amounts of raw materials and chemicals used in a back-end process by the production volume.

4. The method according to claim 1, wherein the calculating of carbon emissions comprises:
calculating carbon emissions by dividing amounts of packaging materials used by production volume;
calculating carbon emissions by dividing an amount of energy used to manufacture the plurality of semiconductor products by production volume; and
calculating carbon emissions by dividing a transportation distance using a transportation method by production volume.

5. A computing system for calculating carbon emissions of a semiconductor product, the system comprising:
a database configured to pre-store carbon emission factors associated with a plurality of raw materials and a plurality of chemicals used to manufacture a semiconductor product;
a data collector configured to collect basic data on the semiconductor product including process-specific data and data on packaging materials, energy, waste, and transportation method;
a calculation component configured to automatically calculate carbon emissions based on usage of the plurality of raw materials and the plurality of chemicals used in the semiconductor product and associated carbon emission factors according to a unique product code of the semiconductor product; and
a data refinement and correction component configured to detect and correct errors in the data collected by the data collector.

6. The system according to claim 5, wherein the data collector comprises:
a basic data collector configured to collect a product name, code, raw material code, and manufacturing information of the semiconductor product;
a front-end process data collector configured to collect process-specific raw material usage, product-specific usage, and production volume for calculating the carbon emissions per wafer or chip unit of the semiconductor product;
a back-end process data collector configured to collect actual raw material usage, raw material withdrawal records, and production performance data of the semiconductor product;
a packaging material data collector configured to collect packaging material usage of the semiconductor product;
a utility data collector configured to collect an amount of power used, an amount of fuel used, and an amount of waste generated during a manufacturing process of the semiconductor product; and
a logistics data collector configured to collect a raw material supplier location, a logistics transportation distance, and a transportation method for the semiconductor product.

7. The system according to claim 5, wherein the calculation component comprises:
a data matcher configured to match the carbon emission factors previously stored in the database with the plurality of raw materials and the plurality of chemicals;
a data converter configured to convert units of the raw materials and chemicals into kilogram units; and
a carbon emission calculator configured to calculate monthly usage based on the previously collected data, and to calculate the carbon emissions using the monthly usage, conversion to kilogram units, and carbon emission factors.

8. The system according to claim 5, further comprising:
a pathway-specific carbon emission analyzer configured to calculate respective emissions according to carbon emission pathways based on the carbon emissions calculated according to the unique product code of the semiconductor product; and
a process searcher configured to reduce the usage of raw materials and chemicals for each semiconductor product based on the calculated carbon emissions according to the unique product code of the semiconductor product.
